(19) United States
(12) Patent Application Publication
(10) Pub. No.: US 2026/0286257 A1
(43) Pub. Date: Sep. 24, 2026

(54) CLEANING COMPOSITIONS WITH N-SUBSTITUTED PIPERAZINES

(71) Applicant: Dow Global Technologies LLC, Midland, MI (US)

(72) Inventors: Xiaolin Ma, Shanghai (CN); Xue Chen, Pearland, TX (US); Dan Jiang, Shanghai (CN)

(21) Appl. No.: 19/469,978

(22) PCT Filed: Jun. 5, 2023
(86) PCT No.: PCT/CN23/98237

§ 371 Date: Sep. 26, 2025

(51) Int. Cl. C11D 7/32; C11D 7/12

(52) U.S. Cl. CPC C11D 7/3281; C11D 7/12; C11D 2111/16

(57) ABSTRACT

A composition comprising at least the following components a and b): a) at least one N-substituted piperazine selected from Structure 1 as described herein; and b) water.

### BACKGROUND OF THE INVENTION

Metal cleaning is an essential operation in modern industrial production, which is implemented before and/or after the metal treatment processes, and during the in-use period of metal equipment. The industrial soils usually include cutting oil, polishing residue, drawing oil, rust, corrosion inhibitors, stamping oil, fingerprints, and dust. Room temperature (or low temperature) cleaning has been a trend in recent years to help reduce energy consumption and increase environmental protection. Lowering the operation (cleaning) temperature can also bring great cost savings.

For room temperature (or low temperature) cleaning operations, foaming resulting from the surfactants is a critical issue to address, in addition to the cleaning performance of the cleaning composition. One approach to “reducing foam” is to use low foam, nonionic surfactants, which has been adopted in metal cleaners by the industry. The foaming of nonionic surfactants is suppressed when the temperature is above the cloud point of the surfactant. However, low foam surfactants are usually designed with low cloud points (for example, below 40° C.). To achieve extreme low foam at room temperature, the cloud point is usually no more than 20° C. This approach has several problems, as follows:
a) formulation compatibility: low foam surfactants are usually hydrophobic and are not well solubilized in alkaline formulation systems, which results in a turbid appearance or phase separation of the cleaning composition that further affects the cleaning efficacy;
b) foam: low foam surfactants may still generate foam under operations that use strong mechanical forces, such as sprayers, shakers or mixers; and also, the surfactants can lose their low foaming properties when solubilized by hydrotropes;
c) emulsification: strong oil bonding is not desired in metal cleaning, because it may reduce the service time of the bath; surfactants usually have good emulsifying power toward oils, and may bond with oils closely, which causes the surfactants to be removed, together with the oils, from the wash bath.

There is a need for metal cleaning compositions that have excellent oil removal performance and low foaming properties, without sacrificing solubility in alkaline formulations, and which can be used at low/ambient temperatures.

U.S. Publication 2022/0254624 discloses a method of cleaning semiconductor substrates. The cleaning liquid shows alkaline properties and contains the following: a) component A that is at least one selected from the group consisting of a primary amine, a secondary amine, and a tertiary amine, provided that a compound represented by a specific formula (a), as described therein, is excluded; and b) a component B that is a compound represented by the specific formula (a). The mass ratio of the component B to the component A is not more than 0.01. The cleaning liquid applied to the semi-conductor substrate has a temperature of not lower than 30° C. See abstract. Component A may be monoethanolamine (MEA), 2-amino-2-methyl-1-propanol (AMP), 2-(methylamino)-2-methyl-1-propanol (N-MAMP), diethanolamine (DEA), diethylene glycol amine (DEGA), tris(hydroxymethyl)aminomethane, ethylenediamine (EDA), 1,3-propanediamine (PDA), diethylenetriamine (DETA), triethylenetetramine (TETA), N-(2-amino-ethyl)piperazine (AEP), 1,4-bis(2-hydroxyethyl)piperazine (BHEP), 1,4-bis(3-aminopropyl)-piperazine (BAPP), or bis(aminopropyl)ethylenediamine (BAPEDA). See paragraph [[0059].

U.S. Pat. No. 9,045,717 discloses a composition comprising a cyclic polyamine, a polyphenol based reducing agent having 2 to 5 hydroxyl groups, a quaternary ammonium hydroxide, ascorbic acid, and water, and wherein the composition is useful for the removal of material from a surface of a microelectronic device. See claim 1. The cyclic polyamine is selected from the group consisting of N-ethylpiperazine, N-isobutylpiperazine, N-aminomethylpiperazine, N-aminopropylpiperazine, N-hydroxypropylpiperazine, 1,4-dimethylpiperazine, 1,4-diethylpiperazine, 1,4-diisopropylpiperazine, 1,4-dibutylpiperazine, 1-aminomethyl-4-methylpiperazine, 1-hydroxymethyl-4-methylpiperazine, 1-aminoethyl-4-ethylpiperazine, 1-hydroxyethyl-4-ethylpiperazine, 1,4-(bis-aminoethyl)piperazine, 1,4-(bis-hydroxyethyl)-piperazine, 1,4-(bis-aminopropyl)piperazine, 1,4-(bis-hydroxypropyl)piperazine, 1-amino-ethyl-4-hydroxyethylpiperazine, 1-aminopropyl-4-hydroxypropylpiperazine, N-aminoisobutyl-morpholine, and combinations thereof. See claim 1. See also column 7, line 64, to column 9, line 5.

International Publication WO2013/138278 discloses a cleaning composition and process for cleaning post-chemical mechanical polishing (CMP) residue and contaminants from a microelectronic device having said residue and contaminants thereon. See abstract. The cleaning composition comprises at least one solvent, at least one corrosion inhibitor, at least one polyamine species, and at least one quaternary base, and wherein the at least one polyamine species is at least one of an aliphatic polyamine or a cyclic polyamine (see claim 1). Examples of the cyclic polyamine include N-methylpiperazine, N-ethylpiperazine, N-is-obutylpiperazine, N-aminomethylpiperazine, N-aminoethylpiperazine, N-aminopropyl-piperazine, N-hydroxy-methylpiperazine, N-hydroxyethylpiperazine, N-hydroxypropyl-piperazine, 1,4-dimethyl-piperazine, 1,4-diethylpiperazine, 1,4-diisopropyl-piperazine, 1,4-dibutylpiperazine, 1-aminomethyl-4-methylpiperazine, I-hydroxymethyl-4-methylpiperazine, 1-aminoethyl-4-ethylpiperazine, 1-hydroxyethyl-4-ethylpiperazine, 1,4-(bis-aminoethyl)-piperazine, 1,4-(bis-hydroxyethyl)piperazine, 1,4-(bisaminopropyl)piperazine, 1,4-(bis-hydroxypropyl)piperazine, 1-aminoethyl-4-hydroxyethylpiperazine, and 1-aminopropyl-4-hydroxypropylpiperazine. Other cyclic polyamines include imidazoline and imidazole derivatives. See paragraph [0033].

CN102639686A (machine translation) discloses a cleaning fluid composition for flat-panel display devices, comprising the following: (a) between 0.05 and 5 wt % of an amine compound; (b) from 0.01 to 10 wt % of an additive comprising one or two or more components selected from the group consisting of azole-based compounds, alkanol amine salts and reducing agents; and (c) a balance of water (see abstract). The amine compound may be selected from N-(2-hydroxyethyl) piperazine, N-(2-hydroxypropyl) piperazine, N-(2-hydroxyl butyl) piperazine, 1-(2-hydroxyethyl)-4-N-methyl piperazine, 1-(2-hydroxypropyl)-4-N-methyl piperazine, 1-(2-hydroxyl butyl)-4-N-methyl piperazine, 1-(2-hydroxyethyl)-4-ethyl piperazidine, 1-(2-hydroxyethyl)-4-propyl group piperazine, 1-(2-hydroxyethyl)-4-butyl piperazine, 1-(2-hydroxypropyl)-4-N-methyl piperazine, 1-(2-hydroxypropyl)-4-ethyl piperazidine, 1-(2-hydroxypropyl)-4-propyl piperazine, 1-(2-hydroxypropyl)-4-butyl piperazine, 1-(2-hydroxyl butyl)-4-N-methyl piperazine, 1-(2-hydroxyl butyl)-4-ethyl piperazidine, 1-(2-hydroxyl butyl)-4-propyl piperazine, 1-(2-hydroxyl butyl)-4-butyl piperazine, N-(2-hydroxyethyl) morpholine, N-(2-hydroxypropyl) morpholine, N-aminocarbonyl propyl morpholine, hydroxyethyl piperazine, hydroxypropyl piperazine, with 1-(N-methyl piperazine) group that ethanol constitutes. See claims 1 and 2.

U.S. Publication 2022/0177814 discloses a cleaning liquid for semiconductor substrates having undergone CMP, and the cleaning liquid contains: an amine compound that is at least one selected from the group consisting of a primary amine, a secondary amine, a tertiary amine, and their salts; a chelating agent; and water. See abstract. The amine compound content is not less than 25.5 mass % and less than 90 mass % based on the total mass of the cleaning liquid, and the water content is 10 to 60 mass % based on the total mass of the cleaning liquid. See abstract. The amine compound may be monoethanolamine (MEA), 2-amino-2-methyl−1-propanol (AMP), 2-(methylamino)-2-methyl-1-propanol (N-MAMP), diethanol-amine (DEA), diethylene glycol amine (DEGA), tris(hydroxymethyl) aminomethane (Tris), ethylenediamine (EDA), 1,3-propanediamine (PDA), diethylenetriamine (DETA), triethylenetetramine (TETA), N-(2-aminoethyl)piperazine (AEP), 1,4-bis(2-hydroxyethyl) piperazine (BHEP), 1,4-bis(2-aminoethyl)piperazine (BAEP), 1,4-bis(3-aminopropyl)piperazine (BAPP), bis(aminopropyl)-ethylenediamine (BAPEDA), ethylamine, triethylamine, or propylamine. See paragraph [0065]. See also paragraph [0046].

KR20130007402A (machine translation) discloses a cleaning liquid composition comprising 0.05 to 10% by weight of a cyclic amine compound, 0.1 to 20% by weight of a water-soluble glycol ether compound, and 79 to 99.5% by weight of water, based on the total weight of the composition. See abstract and claim 1. Cyclic amine compounds represented by Formula 1, as described therein, include N-methylmorpholine, N-ethylmorpholine, N-formylmorpholine, N-(2-hydroxyethyl) morpholine, and N-(3-hydroxy propyl) morpholine, N-(2-hydroxyethyl)-N′-methylpiperazine, N-(2-hydroxyethyl)-N′-ethylpiperazine, N,N′-bis(2-hydroxyethyl) piperazine and the like. These compounds may be used alone or in combination of two or more. See Description section.

JP2003292993A (machine translation) discloses a cleansing agent that comprises an ethyleneamine compound and a cyclic amine such as a piperazine compound and/or a morpholine compound. The piperazine compound includes piperazine, N-methylpiperazine, N,N′-dimethylpiperazine, hydroxyethylpiperazine, N-methyl-N′-hydroxyethylpiperazine, aminoethylpiperazine, and N,N′,N′-trimethylaminoethylpiperazine, bis-(hydroxyethyl) piperazine, hydroxypropylpiperazine, bis(hydroxypropyl) piperazine, N-methyl-N′-hydroxypropylpiperazine, aminopropylpiperazine, bis-(aminoethyl) piperazine, bis-(aminopropyl) piperazine. The morpholine compound includes morpholine, N-methyl morpholine, hydroxyethylmorpholine, aminoethylmorpholine, and N,N-dimethylamino-ethylmorpholine. The ethyleneamine compound includes ethylenediamine and diethylene-triamine. See abstract and paragraph [0011].

Additional compositions are disclosed in WO2011/014027 (English abstract), JP2016086094A (machine translation), JP2015165561A (machine translation) and JP2015165562A (machine translation).

However, as discussed above, there remains a need for metal cleaning compositions that have excellent oil removal performance and low foaming properties, without sacrificing solubility in alkaline formulations, and which can be used at low/ambient temperatures. This need has been met as discussed below.

### SUMMARY OF THE INVENTION

A composition comprising at least the following components a and b):
a) at least one N-substituted piperazine selected from Structure 1) below:

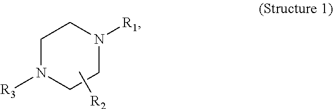

wherein R1 is a C1-C6 alkoxyl group; R2 is H or an alkyl group; R3 is H or a C1-C6 alkoxyl group;
b) water.

### BRIEF DESCRIPTION OF THE DRAWINGS

FIG. 1 is a plot of the boiling point of 1,4-bis(2-hydroxyethyl)piperazine as a function of “mm Hg.” The equation of the profile is y=26.3851n(x)+118.53 (R²=0.9616).

FIG. 2 is a bar graph showing the percentage of oil removal for the noted compositions.

FIG. 3 is a bar graph showing the percentage of oil removal for the noted compositions.

FIG. 4 is a bar graph showing the percentage of oil removal for the noted compositions.

FIG. 5 is a bar graph showing the time for each noted composition to separate from oil and fill a volume of 5 ml or 10 ml.

### DETAILED DESCRIPTION OF THE INVENTION

Compositions have been discovered that provide good cleaning performance and good alkaline tolerance, and have low foaming properties. These compositions are good for cleaning at low or ambient temperatures, and shown excellent oil removal performance and low foaming properties, without sacrificing solubility in alkaline formulations. These properties are desired for metal cleaning processes, especially for cleaning at low/ambient temperatures.

As discussed above, a composition is provided comprising at least the following components a and b):
a) at least one N-substituted piperazine selected from Structure 1) below:

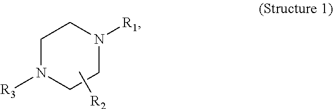

wherein R1 is a C1-C6 alkoxyl group; R2 is H or an alkyl group; R3 is H or a C1-C6 alkoxyl group;
b) water.

The above composition may comprise a combination of two or more embodiments, as described herein. Component a may comprise a combination of two or more embodiments, as described herein. Component b may comprise a combination of two or more embodiments, as described herein. Related processes may each comprise a combination of two or more embodiments, as described herein. As used herein, in regard to Structure 1) of component a, R1=R₁, R2=R₂, R3=R₃.

In one embodiment, or a combination of two or more embodiments, each described herein, the composition further comprises, as component c, at least one alkaline salt, and further a metal carbonate and/or a metal bicarbonate, further a metal carbonate.

In one embodiment, or a combination of two or more embodiments, each described herein, the weight ratio of component c to component a is ≥2.0, or ≥2.5, or ≥3.0, or ≥3.5, or ≥4.0. In one embodiment, or a combination of two or more embodiments, each described herein, the weight ratio of component c to component a is ≤10, or ≤9.5, or ≤9.0, or ≤8.5, or ≤8.0, or ≤7.5, or ≤7.0, or ≤6.5, or ≤6.0.

In one embodiment, or a combination of two or more embodiments, each described herein, the composition comprises ≥88 wt %, or ≥89 wt %, or ≥90 wt %, or ≥91 wt %, or ≥92 wt %, or ≥93 wt %, or ≥94 wt %, or ≥95 wt %, or ≥96 wt %, or ≥97 wt %, or ≥98 wt % the sum of components a and b, based on the weight of the composition. In one embodiment, or a combination of two or more embodiments, each described herein, the composition comprises ≤100 wt %, or ≤99 wt %, the sum of components a and b, based on the weight of the composition.

In one embodiment, or a combination of two or more embodiments, each described herein, for component a, Structure 1, R1=R3.

In one embodiment, or a combination of two or more embodiments, each described herein, for component a, Structure 1, R2=H.

In one embodiment, or a combination of two or more embodiments, each described herein, for component a, Structure 1, R1 is a C2-C6 alkoxyl, further a C2-C5 alkoxyl, further a C2-C4 alkoxyl, further a C2-C3 alkoxy, further a C2 alkoxyl.

In one embodiment, or a combination of two or more embodiments, each described herein, for component a, Structure 1, R3 is a C2-C6 alkoxyl, further a C2-C5 alkoxyl, further a C2-C4 alkoxyl, further a C2-C3 alkoxy, further a C2 alkoxyl.

In one embodiment, or a combination of two or more embodiments, each described herein, for component a, Structure 1, R3 is H.

In one embodiment, or a combination of two or more embodiments, each described herein, component a is at least one structure selected from the group consisting of the following structures 1a) through 1c) as shown below:
1a)

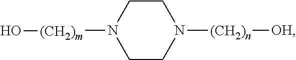

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and further n=m;
1b)

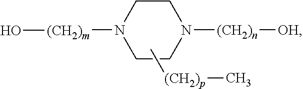

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and p is an integer from 1 to 6, further from 1 to 5, further from 1 to 4, further from 1 to 3, further from 1 to 2, further 1; and further n=m; and 1c) a mixture of 1a) and structure 1b).

In one embodiment, or a combination of two or more embodiments, each described herein, the component c is a metal carbonate, and further sodium carbonate.

In one embodiment, or a combination of two or more embodiments, each described herein, component a is present in an amount ≥0.01 wt %, or 0.02 wt %, or ≥0.05 wt %, or 0.10 wt %, or ≥0.20 wt %, or ≥0.30 wt %, or ≥0.40 wt %, or ≥0.50 wt %, or 0.70 wt %, or ≥1.0 wt %, based on the weight of the composition. In one embodiment, or a combination of two or more embodiments, each described herein, component a is present in an amount ≤20 wt^{%}, or ≤15 wt %, or ≤10 wt %, or ≤8.0 wt %, or ≤6.0 wt %, or ≤5.5 wt %, or ≤5.0 wt %, or ≤4.5 wt %, or ≤4.0 wt %, or ≤3.5 wt %, or ≤3.0 wt %, based on the weight of the composition.

In one embodiment, or a combination of two or more embodiments, each described herein, component b is present in an amount ≥70.0 wt %, or ≥72.0 wt %, or ≥75.0 wt %, or ≥78.0 wt %, or ≥80.0 wt %, or ≥82.0 wt %, or ≥84.0 wt %, or ≥86.0 wt %, or ≥88.0 wt %, or ≥90.0 wt %, or ≥92.0 wt %, or ≥95.0 wt %, based on the weight of the composition. In one embodiment, or a combination of two or more embodiments, each described herein, the component b is present in an amount ≤100.0 wt %, or ≤99.5 wt %, or ≤99.0 wt %, or ≤98.5 wt %, or ≤98.0 wt %, based on the weight of the composition.

In one embodiment, or a combination of two or more embodiments, each described herein, the sum of component a, b and c is present in an amount ≥95.0 wt %, or 95.5 wt %, or ≥96.0 wt %, or 96.5 wt %, or ≥97.0 wt %, or ≥97.5 wt %, or ≥98.0 wt %, or ≥98.5 wt %, or ≥99.0 wt %, based on the weight of the composition. In one embodiment, or a combination of two or more embodiments, each described herein, the sum of component a, b and c is present in an amount ≤100 wt %, or ≤99.8 wt %, or ≤99.6 wt %, based on the weight of the composition.

In one embodiment, or a combination of two or more embodiments, each described herein, the composition further comprises, as component d, a metal chelate.

In one embodiment, or a combination of two or more embodiments, each described herein, the weight ratio of component d to component a is ≥0.80, or ≥0.85, or ≥0.90, or ≥0.95, or ≥1.00. In one embodiment, or a combination of two or more embodiments, each described herein, the weight ratio of component d to component a is ≤1.20, or ≤1.15, or ≤1.10, or ≤1.05, or ≤1.02.

In one embodiment, or a combination of two or more embodiments, each described herein, the composition has an “oil removal %”≥60%, or ≥62%, or ≥65%, or ≥67%, or ≥70%, or ≥72%, or ≥74%, or ≥76%, or ≥78%, or ≥80%, as determined from the equation [(W2-W3)/(W2-W1)]×100, where W1=weight of a stainless steel coupon, W2=weight of the oil soiled coupon, and W3=weight of the dried coupon after subject to cleaning evaluation with the composition (see experimental section).

In one embodiment, or a combination of two or more embodiments, each described herein, the composition generates a foam height ≤5 mm, or ≤4 mm, or ≤3 mm, or ≤2 mm, or ≤1 mm, or 0 mm, after 60 seconds of shaking using a high throughput robot (see experimental section).

Also provided is a process to form the composition of any one embodiment, or a combination of two or more embodiments, each described herein, the process comprising mixing at least components a and b.

Also provided is a process to clean a metal surface, the process comprising applying to the metal surface the composition of any one embodiment, or a combination of two or more embodiments, each described herein.

In one embodiment, or a combination of two or more embodiments, each described herein, the temperature of the composition is ≥18° C., or ≥19° C., or ≥20° C., or ≥22° C. and/or ≤30° C., or ≤29° C., or ≤28° C., or ≤27° C., or ≤26° C., or ≤25° C., or ≤24° C. when applied to the metal surface.

In one embodiment, or a combination of two or more embodiments, each described herein, the process is an industrial cleaning process.

Component a—Structure 1

Component a is described herein as Structure 1. Syntheses of such N-substituted piperazine are known in the art, and various piperazines are also commercially available. For example, an N-substituted piperazine can be generated by reacting the oxides of interest with the piperazine. As an example, 1,4-bis(2-hydroxyethyl)piperazine can be synthesized by reacting the EO (ethylene oxide) and the piperazine at the targeted ratio of 2:1. The resulting piperazine can be recovered using conventional technologies. Note, the term N-substituted piperazine, as used herein, refers to an N-substitution and an N,N′-substitution on the piperazine ring.

Component a can be in the form of a liquid composition that is added to an aqueous composition. The piperazine of Structure 1, per se, can be in the form of a liquid at room temperature (22° C.), and therefore a “stock” composition can be one where the piperazine is in neat form (100% wt). A stock composition can also be prepared with the piperazine in one or more compatible solvents, such as, for example, where the piperazine is present in an amount in the range of about 30% (wt) to about 99% (wt). The solvent may be water. The piperazine may be in the form of a solid composition, such as in powder or granule form that can be added to an aqueous composition.

Component c—Alkaline Salt

An alkaline salt is the product of a strong base and a weak acid, and which can form basic solution upon dissolution in water. Alkaline salts include, but are not limited to, sodium carbonate, sodium acetate, sodium hydroxide, potassium hydroxide, sodium bicarbonate, sodium chloride, and sodium sulfide. An alkaline salt may be selected from a metal bicarbonate, a metal carbonate, a metal chloride, a metal chlorate, a metal nitrate, a metal phosphate, a metal sulfate, a metal sulfide, or a mixture thereof. A composition may comprise one or more alkaline salts.

Component d—Chelate

Chelates are known in the art. A chelate typically comprises at least two ligand that are bonded to a central metal atom. Chelates include, but are not limited to, salts of ethylene diamine tetraacetic acid and the derivatives thereof; aminocarboxylate chelating agents, such as a salt of glutamic-N,N-diacetic acid; phosphate chelating agents; phosphonate chelating agents, such as ethylene diamine tetramethylene phosphonates, and diethylene triamine pentamethylene phosphonates. These chelates may be present either in their acid form or as salts. Biodegradable chelating agents include, but are not limited to, ethylene diamine N,N′-disuccinic acid, or alkali metal, or alkaline earth metal, ammonium or substitutes ammonium salts thereof, or mixtures thereof; and L-glutamic acid N,N-diacetic acid (GLDA) commercially available under tradename DISSOLVINE 47S from Akzo Nobel.

Suitable amino carboxylates or acids include ethylene diamine tetraacetates, ethylene triamine pentaacetates, diethylene triamine pentaacetate (DTPA), N-hydroxyethylethylene-diamine triacetates, nitrilotriacetates, ethylenediamine tetrapropionates, triethylenetetramine-hexaacetates, ethanoldiglycines, and methyl glycine diacetic acid (MGDA), both in their acid form, or in their alkali metal, ammonium, and substituted ammonium salt forms. Particularly suitable amino carboxylates or acids include, but are not limited to, salts of ethylene diamine tetraacetic acid (EDTA); EDTA; propylene diamine tetracetic acid (PDTA) which is, for instance, commercially available from BASF under the trade name TRILON FS; methylglycine di-acetic acid (MGDA); and diethylene triamine pentaacetate (DTPA) from BASF. Further carboxylate chelating agents include salicylic acid, aspartic acid, glutamic acid, glycine, malonic acid or mixtures thereof.

In one embodiment, or a combination of two or more embodiments, each described herein, component d is an ethylene diamine tetraacetic acid, or a salt thereof, such as EDTA-4Na·H2O.

### Other Additives

A composition, as described herein, may optionally include one or more additional additive(s). Examples of additives include, but are not limited to, solvents, surfactants, block or random copolymers of ethylene oxide/propylene oxide, butylene oxide/propylene oxide, ethylene oxide/butylene oxide; waxes; silicone-based materials; foam control compounds, such as agents produced by the alkoxylation of alcohol(s), alkyl polyglucosides, ketal foam control agents, and cellulose derivative foam control agents. An additive may be present in an amount of ≥0.01 wt %, or ≥0.02 wt %, or ≥0.05 wt %, or ≥0.10 wt %, or ≥0.20 wt %, or ≥0.40 wt %, or ≥0.60 wt %, or ≥0.80 wt %, and/or ≤20 wt %, or ≤10 wt %, or ≤5.0 wt %, or ≤3.0 wt %, or ≤2.0 wt %, or ≤1.0 wt %, based on the weight of the composition.

### Definitions

Unless stated to the contrary, implicit from the context, or customary in the art, parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “water,” as used herein, refers to H₂O or an H₂O sample. Such a water (H₂O) sample is virtually pure water, and, as such, may or may not contain one or more impurities, such as, for example, dissolved inorganic ions. Typically, the impurities are present in an amount ≤5000 ppm, preferable ≤2000 ppm, preferably, ≤1000 ppm, preferably ≤500 ppm, more preferably ≤300 ppm, more preferably ≤100 ppm, based on the weight of the water sample.

The phrase “applying to the metal surface,” in reference to the process of cleaning a metal surface with a composition, described herein, refers to the act of contacting the metal surface with the composition. This contact may occur by wetting the metal surface with the composition using a spray, a brush, a roller, or by dipping the metal into the composition, or by any other means known in the art.

The term “industrial cleaning process,” as used herein, refers to a process used to clean equipment surfaces and other surfaces used in an industrial facility, such as, for example, floors, walls, ceilings, equipment exterior and interior surfaces, and other surfaces.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition and Process Features

A] A composition comprising at least the following components a and b):
a) at least one N-substituted piperazine selected from Structure 1) below:

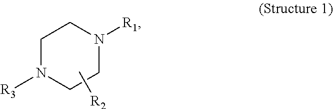

wherein R1 is a C1-C6 alkoxyl group; R2 is H or an alkyl group; R3 is H or a C1-C6 alkoxyl group;
b) water.
B] The composition of A] above, where the composition further comprises, as component c, at least one alkaline salt.
C] The composition of B] above, where component c is a metal carbonate and/or a metal bicarbonate, further a metal carbonate.
D] The composition of B] or C] above, where the weight ratio of component c to component a is ≥2.0, or ≥2.5, or ≥3.0, or ≥3.5, or ≥4.0.
E] The composition of any one of B]-D](B] through D]) above, where the weight ratio of component c to component a is ≤10, or ≤9.5, or ≤9.0, or ≤8.5, or ≤8.0, or ≤7.5, or ≤7.0, or ≤6.5, or ≤6.0.
F] The composition of any one of A]-E] above, where the composition comprises ≥88 wt %, or ≥89 wt %, or ≥90 wt %, or ≥91 wt %, or ≥92 wt %, or ≥93 wt %, or ≥94 wt %, or ≥95 wt %, or ≥96 wt %, or ≥97 wt %, or ≥98 wt % the sum of components a and b, based on the weight of the composition.
G] The composition of any one of A]-F] above, where the composition comprises ≤100 wt %, or ≤99 wt %, the sum of components a and b, based on the weight of the composition.
H] The composition of any one of A]-G] above, where the weight ratio of component b to component a is ≥5.0, or ≥6.0, or ≥7.0, or ≥8.0, or ≥9.0, or ≥10, or ≥12, or ≥14, or ≥16, or ≥18.
I] The composition of any one of A]-H] above, where the weight ratio of component b to component a is ≤300, or ≤250, or ≤200, or ≤150, or ≤100, or ≤90, or ≤80, or ≤70, or ≤60, or ≤50, or ≤40, or ≤35, or ≤30, or ≤25.
J] The composition of any one of A]-I] above, where, for component a, Structure 1, R1=R3.
K] The composition of any one of A]-J] above, where, for component a, Structure 1, R2=H.
L] The composition of any one of A]-J] above, where, for component a, Structure 1, R2=an alkyl, and further a C1-C5 alkyl, further a C₁-C₄ alkyl, further a C₁-C₃ alkyl, further a C1-C2 alkyl, further a C1 alkyl.
M] The composition of any one of A]-L] above, where, for component a, Structure 1, R1 is a C1-C5 alkoxyl, further a C₁-C₄ alkoxyl, further a C1-C3 alkoxyl, further a C1-C2 alkoxy.
N] The composition of any one of A]-L] above, where, for component a, Structure 1, R1 is a C2-C6 alkoxyl, further a C2-C5 alkoxyl, further a C2-C4 alkoxyl, further a C2-C3 alkoxy, further a C2 alkoxyl.
O] The composition of any one of A]-N] above, where, for component a, Structure 1, R3 is a C1-C5 alkoxyl, further a C₁-C₄ alkoxyl, further a C₁-C₃ alkoxyl, further a C1-C2 alkoxy.
P] The composition of any one of A]-N] above, where, for component a, Structure 1, R3 is a C2-C6 alkoxyl, further a C2-C5 alkoxyl, further a C2-C4 alkoxyl, further a C2-C3 alkoxy, further a C2 alkoxyl.
Q] The composition of any one of A]-N] above, where, for component a, Structure 1, R3 is H.
R] The composition of any one of A]-Q] above, where component a is at least one structure selected from the group consisting of the following structures 1a) through 1c) as shown below:
1a),

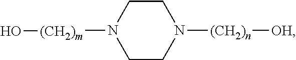

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and further n=m;
1b)

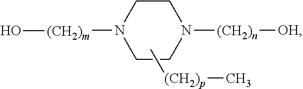

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and p is an integer from 1 to 6, further from 1 to 5, further from 1 to 4, further from 1 to 3, further from 1 to 2, further 1; and further n=m; and 1c) a mixture of structure 1a) and structure 1b).
S] The composition of R] above, where component a is at least one structure selected from Structure 1a), as shown above, and further n=m, further n=m=2 or 3, further n=m=2.
T] The composition of R] above, where component a is at least one structure selected from Structure 1b), as shown above, and further n=m, further n=m=2 or 3, further n=m=2.
U] The composition of R] above, where component a is at least one structure selected from 1c), as shown above.
V] The composition of any one of A]-Q] above, where component a is at least one structure selected from the group consisting of the following structures 2a) through 2c) as shown below:
2a)

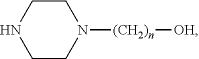

where n is an integer from 1 to 6, further from 1 to 5, further from 1 to 4, further from 2 to 4, further from 2 to 3, further 2;
2b)

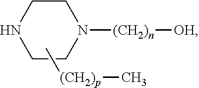

where n is an integer from 1 to 6, further from 1 to 5, further from 1 to 4, further from 2 to 4, further from 2 to 3, further 2; and p is an integer from 1 to 6, further from 1 to 5, further from 1 to 4, further from 1 to 3, further from 1 to 2, further 1; and 2c) a mixture of structure 2a) and structure 2b).
W] The composition of V] above, where component a is at least one structure selected from Structure 2a), as shown above, and further n=2.
X] The composition of V] above, where component a is at least one structure selected from Structure 2b), as shown above, and further n=2.
Y] The composition of V] above, where component a is at least one structure selected from 2c), as shown above.
Z] The composition of any one of A]-Y] above, where for component a, Structures 1) has a molecular weight ≥80, or ≥90, or ≥100, or ≥110, or ≥120, or ≥125, r ≥127, or ≥130 g/mol.
A2] The composition of any one of A]-Z] above, where for component a, Structures 1) has a molecular weight ≤500, or ≤450, or ≤400, or ≤350, or ≤300, or ≤250, or ≤200, or ≤180 g/mol.
B2] The composition of any one of A]-A2] above, where for component a, Structure 1) has a molecular weight ≤220, or ≤210, or ≤200, or ≤195, or ≤190, or ≤185, or ≤180 g/mol.
C2] The composition of any of A]-B2] above, where for component a, Structures 1) has a boiling point (at 760 mm Hg) ≥200° C., or ≥205° C., or ≥210° C., or ≥215° C., or ≥220° C., or ≥230° C., or ≥240° C., or ≥245° C., or ≥250° C., or ≥255° C., or ≥260° C., or ≥265° C., or ≥270° C.
D2] The composition of any one of A]-C2] above, where for component a, Structures 1) has a boiling point (at 760 mm Hg)≤400° C., or ≤380° C., or ≤360° C., or ≤340° C., or ≤330° C., or ≤320° C., or ≤310° C.
E2] The composition of any one of B]-D2] above, where component c is a metal carbonate, and further sodium carbonate.
F21 The composition of any one of B]-E2] above, where the metal of component c has an atomic mass ≥8, or ≥10, or ≥12, or ≥15, or ≥18, or ≥20, or ≥22 g/mol.
G2] The composition of any one of B]-F2] above, where the metal of component c has an atomic mass ≤60, or ≤58, or ≤55, or ≤52, or ≤50, or ≤48, or ≤46, or ≤44, or ≤42 g/mol.
H2] The composition of any one of B]-G2] above, where the metal carbonate or metal bicarbonate of component c has an molecular weight ≥60, or ≥65, or ≥70, or ≥75, or ≥80, or ≥82, or ≥84, or ≥86, or ≥88, or ≥90, or ≥92, or ≥94, or ≥96, or ≥98, or ≥100 g/mol. 121 The composition of any one of B]-H2] above, where the metal carbonate or metal bicarbonate of component c has an molecular weight ≤250, or ≤200, or ≤150, or ≤140, or ≤130, or ≤120, or ≤115, or ≤110 g/mol.
J2] The composition of any one of B]-I2] above, where the component c is present in an amount 0.01 wt %, or ≥0.02 wt %, or ≥0.05 wt %, or ≥0.10 wt %, or ≥0.20 wt %, or ≥0.30 wt %, or ≥0.40 wt %, or ≥0.50 wt %, or ≥1.0 wt %, or ≥1.5 wt %, or ≥2.0 wt %, based on the weight of the composition.
K2] The composition of any one of B]-J2] above, where the component c is present in an amount ≤15 wt %, or ≤12 wt %, or ≤10 wt %, or ≤9.0 wt %, or ≤8.0 wt %, or ≤7.0 wt %, or ≤6.0 wt %, or ≤5.0 wt %, based on the weight of the composition.
L2] The composition of any one of A]-K2] above, where the component a is present in an amount ≥0.01 wt %, or 0.02 wt %, or ≥0.05 wt %, or 0.10 wt %, or ≥0.20 wt %, or ≥0.30 wt %, or ≥0.40 wt %, or ≥0.50 wt %, or 0.70 wt %, or ≥1.0 wt %, based on the weight of the composition.
M2] The composition of any one of A]-L2] above, where the component a is present in an amount ≤20 wt %, or ≤15 wt %, or ≤10 wt %, or ≤8.0 wt %, or ≤6.0 wt %, or ≤5.5 wt %, or ≤5.0 wt %, or ≤4.5 wt %, or ≤4.0 wt %, or ≤3.5 wt %, or ≤3.0 wt %, based on the weight of the composition.
N2] The composition of any one of A]-M2] above, where the component b is present in an amount ≥70.0 wt %, or ≥72.0 wt %, or ≥75.0 wt %, or ≥78.0 wt %, or ≥80.0 wt %, or ≥82.0 wt %, or ≥84.0 wt %, or ≥86.0 wt %, or ≥88.0 wt %, or ≥90.0 wt %, or ≥92.0 wt %, or ≥95.0 wt %, based on the weight of the composition. 02] The composition of any one of A]-N2] above, where the component b is present in an amount ≤100.0 wt %, or ≤99.5 wt %, or ≤99.0 wt %, or ≤98.5 wt %, or ≤98.0 wt %, based on the weight of the composition.
P2] The composition of any one of B]-O2] above, where the sum of component a, b and c is present in an amount ≥95.0 wt %, or 95.5 wt %, or ≥96.0 wt %, or 96.5 wt %, or ≥97.0 wt %, or ≥97.5 wt %, or ≥98.0 wt %, or ≥98.5 wt %, or ≥99.0 wt %, based on the weight of the composition.
Q2] The composition of any one of B]-P2] above, where the sum of component a, b and c is present in an amount ≤100 wt %, or ≤99.8 wt %, or ≤99.6 wt %, based on the weight of the composition.
R2] The composition of any one of A]-Q2] above, where the composition further comprises, as component d, a metal chelate.
S21 The composition of R2] above, where component d comprises an amino carboxylate chelate, a phosphonate chelate or a phosphate chelate.
T2] The composition of R2] or K2] above, where component d comprises a metal salt of ethylene diamine tetraacetic acid, and further comprises ETDA-4·Na-4H2O.
U2] The composition of any one of R2]-T2] above, where component d is present in an amount ≥0.01 wt %, or ≥0.02 wt %, or ≥0.05 wt %, or ≥0.1 wt %, or ≥0.2 wt %, or ≥0.3 wt %, or ≥0.4 wt %, or ≥0.5 wt %, based on the weight of the composition.
V2] The composition of any one of R2]-U2] above, where component d is present in an amount ≤10 wt %, or ≤8.0 wt %, or ≤6.0 wt %, or ≤5.0 wt %, or ≤4.0 wt %, or ≤3.0 wt %, or ≤2.0 wt %, or ≤1.5 wt %, or ≤1.0 wt %, or ≤0.8 wt %, or ≤0.6 wt % based on the weight of the composition.
W2] The composition of any one of R2]-V2] above, where the weight ratio of component d to component a is ≥0.80, or ≥0.85, or ≥0.90, or ≥0.95, or ≥1.00.
X2] The composition of any one of R2]-W2] above, where the weight ratio of component d to component a is ≤1.20, or ≤1.15, or ≤1.10, or ≤1.05, or ≤1.02.
Y2] The composition of any one of R2]-X2] above, where the sum of component a, b, c and d is present in an amount ≥98.0 wt %, or ≥98.5 wt %, or ≥99.0 wt %, or ≥99.5 wt %, based on the weight of the composition.
Z2] The composition of any one of R2]-Y2] above, where the sum of component a, b, c and d is present in an amount ≤100 wt %, or ≤99.9 wt %, or ≤99.8 wt %, based on the weight of the composition.
A3] The composition of any one of A]-Z2] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a surfactant, based on the weight of the composition, and further the composition does not comprise a surfactant.
B3] The composition of any one of A]-A3] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a glycol ether, based on the weight of the composition, and further the composition does not comprise a glycol ether.
C3] The composition of any one of A]-B3] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of ethylamine, based on the weight of the composition, and further the composition does not comprise ethylamine.
D3] The composition of any one of A]-C3] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of an alkylamine, based on the weight of the composition, and further the composition does not comprise an alkylamine.
E3] The composition of any one of A]-D3] above, where the composition has an “oil removal %”≥60%, or ≥62%, or ≥65%, or ≥67%, or ≥70%, or ≥72%, or ≥74%, or ≥76%, or ≥78%, or ≥80%, as determined from the equation [(W2-W3)/(W2-W1)]×100, where W1, W2 and W3 are each defined herein (see experimental section).
F3] The composition of any one of A]-E3] above, where the composition has an “oil removal %”≤100%.
G3] The composition of any one of A]-F3] above, where the composition generates a foam height ≤5 mm, or ≤4 mm, or ≤3 mm, or ≤2 mm, or ≤1 mm, or 0 mm, after 60 seconds of shaking as described herein (see experimental section).
H3] The composition of any one of A]-G3] above, where the composition generates a foam height ≥0 mm, after 60 seconds of shaking, as described herein.
I3] The composition of any one of A]-H3] above, where the composition separates from oil and fills a “10 ml” volume in a time ≤10, or ≤9, or ≤8, or ≤7 seconds, as determined by the emulsification evaluation, as described herein (see experimental section).
J3] The composition of any one of A]-I3] above, where the composition separates from oil and fills a “10 ml” volume in a time ≥2, or ≥3 seconds.
K3] The composition of any one of A]-J3] above, where the composition separates from oil and fills a “5 ml” volume in a time ≤5, or ≤4, or ≤3, or ≤2, or ≤1 seconds, as determined by the emulsification evaluation, as described herein (see experimental section).
L3] The composition of any one of A]-K3] above, where the composition separates from oil and fills a “5 ml” volume in a time ≥0, or ≥1 second.
M3] The composition of any one of A]-L3] above, where the composition is a clear solution; and further a clear solution at a temperature from 21° C. to 23° C.
N3] The composition of any one of A]-M3] above, where the components of the composition are soluble in the composition; and further the components of the composition are soluble in the composition at a temperature from 21° C. to 23° C.
A4] A process to form the composition of any one of A]-N3] above, the process comprising mixing at least components a and b.
B4] The process of A4] above, where the process comprises mixing at least components a, b and c.
C4] The process of A4] or B4] above, where the mixing takes place at a temperature from 18° C., or ≥19° C., or ≥20° C. and/or ≤27° C., or ≤26° C., or ≤25° C. or ≤24° C., or ≤23° C.
D4] The process of any one of A4]-C4], where the mixing takes at ambient atmosphere.
E4] A process to clean a metal surface, the process comprising applying to the metal surface the composition of any one of A]-N3] above.
F4] The process of E4] above, where the metal of the metal surface is selected from steel, stainless steel, brass, chrome, iron, cast iron, aluminum, aluminum alloy, copper, copper alloy, or gold.
G4] The process of E4] or F4] above, where the temperature of the composition is ≥18° C., or ≥19° C., or ≥20° C., or ≥22° C. and/or ≤30° C., or ≤29° C., or ≤28° C., or ≤27° C., or ≤26° C., or ≤25° C., or ≤24° C. when applied to the metal surface.
H4] The process of any one of E4]-G4] above, where the process is an industrial cleaning process.
I4] The composition of any one of A2]-N3] above, where the composition is used to clean metal surfaces.
J4] The composition of 14] above, where the metal of the metal surface is selected from steel, steel, brass, chrome, iron, cast iron, aluminum, aluminum alloy, copper, copper alloy, or gold.

### EXPERIMENTAL

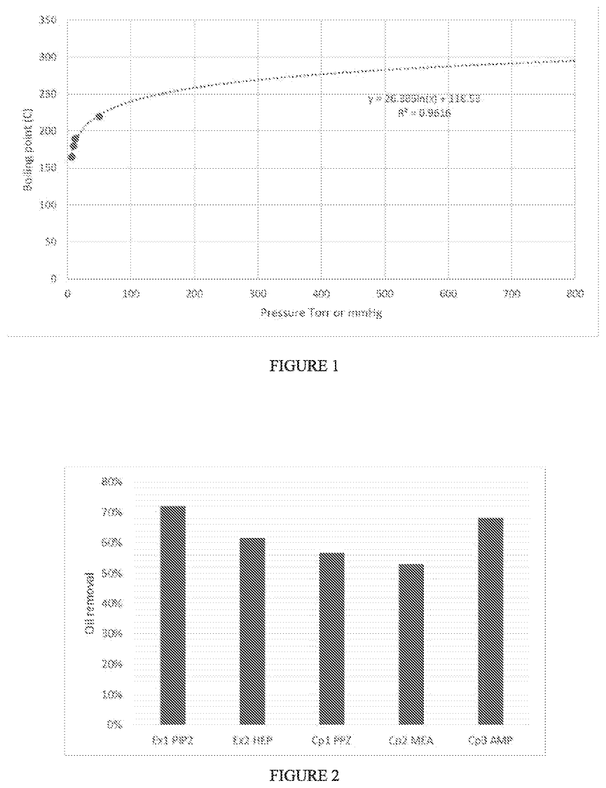

Reagents are shown in Table 1a below and boiling points for 1,4-bis(2-hydroxyethyl)-piperazine are listed in Table 1b (see also FIG. 1). Test materials are shown in Table 2 below.

TABLE 1a
Reagents

| Reagent | Abbrev. |
|---|---|
| 1,4-Bis(2-hydroxyethyl)piperazine, available from | PIP1 |
| Sinopharm Chemical Reagent | |
| 1,4-Bis(2-hydroxyethyl)piperazine | PIP2 |
| N-hydroxyethyl piperazine, available from | HEP* |
| Sinopharm Chemical Reagent | |
| Piperazine, available from Sinopharm | PPZ** |
| Chemical Reagent | |
| 2-amino-2-methyl-1-propanol, available from | AMP*** |
| Sinopharm Chemical Reagent | |
| Ethanolamine MEA, available from The Dow | MEA**** |
| Chemical Company | |
| ECOSURF LFE-1410, available from The Dow | Surfactant |
| Chemical Company | |
| ECOSURF LFE-635, available from The Dow | Surfactant |
| Chemical Company | |
| PLURAFAC LF 900, available from BASF | Surfactant |

*Boiling Point = 246° C. at 760 mm Hg.
**Boiling Point = 146° C. at 760 mm Hg.
***Boiling Point = 165° C. at 760 mm Hg.
****Boiling Point = 170° C. at 760 mm Hg.

TABLE 1b
Boiling Points 1,4-Bis(2-hydroxyethyl)-piperazine

| | | Boiling | |
|---|---|---|---|
| | | Point | |
| | Pressure | degree | |
| | (mm Hg) | C. | Source |
| Experimental | 50 | 220 | (1) Pyman, F. L.; Journal of the |
| | | | Chemical Society, Transactions, |
| | | | (1908), 93, 1793-1807, CAplus |
| Experimental | 12 | 190 | (3) Demarcq, Michel Charles; |
| | | | Compt. rend., (1961), 252, |
| | | | 3454-6, CAplus |
| Experimental | 10 | 180 | (4) Gold-Aubert, Ph.; Helvetica |
| | | | Chimica Acta, (1959), 42, |
| | | | 1156-9, CAplus |
| Experimental | 7 | 165 | (5) Dell, H. D.; |
| | | | Naturwissenschaften, (1966), |
| | | | 53(16), 405, CAplus |
| Predicted | 760 | 305 | (1) Calculated using Advanced |
| | | | Chemistry Development |
| | | | (ACD/Labs) Software V11.02 |
| | | | ( © 1994-2023 ACD/Labs) |
| Extrapolated* | 760 | 294 | extrapolated based on the |
| Average** | 760 | 300 | equation in the plot |

*See FIG. 1.
**Average = [(Predicted + Extrapolated)/2]

TABLE 2
Test Materials

| Name | | Source |
|---|---|---|
| Stamping oil | 320A | Shanghai Parkerizing |
| 304 stainless-steel | 50 mm × 25 | Shanghai Luosong Equipment |
| coupon | mm × 2 mm | |
| Sodium Carbonate | | Sinopharm Chemical Reagent |
| EDTA-4Na•4H2O | SCRC-20181214 | Sinopharm Chemical Reagent |
| (metal chelate) | | |
| Liquid paraffin | | Sinopharm Chemical Reagent |

### Compositions

Compositions for cleaning are shown in Tables 3 and 4 below. See also Tables 5 and 6.

TABLE 3
Cleaning Compositions*

| | | Wt % | Wt % Deionized |
|---|---|---|---|
| Composition | Amine | Amine | Water (DI) |
| Example 1 | PIP2 | 3.0 | 97.0 |
| Example 2 | HEP | 3.0 | 97.0 |
| Comparative 1 | PPZ | 3.0 | 97.0 |
| Comparative 2 | MEA | 3.0 | 97.0 |
| Comparative 3 | AMP | 3.0 | 97.0 |

*Each wt % is based on the weight of the composition.
Minimal foaming is expected for each of Examples 1 and 2.

TABLE 4
Cleaning Compositions*

| | Amine or | Wt % | Wt % Sodium | Wt % EDTA- | Wt % Deionized |
|---|---|---|---|---|---|
| Composition | Surfactant | Amine | carbonate | 4Na•4H₂O | Water (DI) |
| Example 3 | PIP2 | 0.5 | 2.0 | 0.5 | 97.0 |
| Example 4 | HEP | 0.5 | 2.0 | 0.5 | 97.0 |
| Comparative 4 | LFE-1410 | 0.5 | 2.0 | 0.5 | 97.0 |
| Comparative 5 | LFE-635 | 0.5 | 2.0 | 0.5 | 97.0 |
| Comparative 6 | LF 900 | 0.5 | 2.0 | 0.5 | 97.0 |
| Comparative 7 | PPZ | 0.5 | 2.0 | 0.5 | 97.0 |
| Comparative 8 | MEA | 0.5 | 2.0 | 0.5 | 97.0 |
| Comparative 9 | AMP | 0.5 | 2.0 | 0.5 | 97.0 |

*Each wt % is based on the weight of the composition.

Each composition, as shown herein, was prepared by mixing the noted reagents at room temperature (RT, approx. 22° C.). For each composition of Table 3 and Table 6, the amine was added to the deionized water (DI water), and the solution was mixed to form a cleaning composition. For each composition of Table 4 and Table 5, the sodium carbonate and EDTA-4Na·4H₂O was dosed into the DI water, and the resulting solution was mixed until the powders dissolved, to form an first composition. Then, the amine was added into the first composition to form a final composition, which was mixed until a homogeneous suspension or a complete dissolution was formed.

### Testing and Results

### Metal Cleaning Evaluation (Oil Removal)

A stainless steel (ss) coupon (see Table 2) was washed under running DI water for about 10 seconds, and then rinsed by spraying acetone from a squeeze bottle onto the coupon, until all the surfaces on the coupon were covered. The washed and rinsed coupon was blow-dried at room temperature and then weighed. The weight of the dried ss coupon was recorded as W1.

A cleaning composition (45 g, see Table 3, Table 4, Table 5 and Table 6) was added to a 50 mL PP bottle. The dried ss coupon was tared on a scale, and stamping oil (0.20 g+/−0.01 g) was applied to the top surface of the coupon by a drip tube. The coupon was carefully rotated to ensure the oil was evenly spread on the coupon surface. The weight of the soiled coupon was recorded as W2.

The soiled coupon was inserted into the cleaning composition (50 ml bottle), at room temperature (RT, approx. 22° C.), using a tweezer, and a timer was immediately started. After 20 minutes (for compositions of Table 3) or ten minutes (for compositions of Table 4 and Table 5), the coupon was taken out of the composition, and rinsed by putting the coupon into 200 mL of DI water (in a 250 mL beaker) for about 3-5 seconds.

The rinsed coupon was placed in a metal tray (“top surface” facing up) situated on top of a laboratory benchtop, and the coupon was air dried at room temperature for a day. The weight of the dried coupon was recorded as W3. The percentage of the oil removed by the cleaning composition (or “oil removal %”) was calculated using the following formula: [(W2−W3)/(W2−W1)]×100. Results are shown in FIG. 2 (compositions of Table 3) and FIG. 3 (compositions of Table 4). For each composition, in Tables 3 and 4, three test coupons were examined per composition, and an average reported. Results are also shown in Table 5. For each composition in Table 5, two test coupons were examined per composition, and an average reported.

As seen in FIG. 2, for the compositions of Table 3, the Example 1 (PIP 2) had the best oil removal efficacy than the comparative examples and Example 2 (HEP).

As seen in FIG. 3, for the compositions of Table 4, Examples 3 (PIP 2) and 4 (HEP) showed better cleaning performance than Comparative 4 (LFE-1410), and comparable cleaning performance to Comparative 6 (LF 900).

As seen in Table 5, better oil removal was observed for a “c/a weight ratio” from 4.0 to 10.0. Applicant notes that at higher c/a ratios the solution may become turbid in appearance due to some insolubility of the sodium carbonate, especially at higher amounts of the PIP (>0.50 wt %).

TABLE 5
Cleaning Compositions and Oil Removal Results*

| | | | Sodium | | EDTA- | c/a Wt. | |
|---|---|---|---|---|---|---|---|
| Example | PIP1 (a) | Water | Carbonate (c) | | 4Na•4H2O | Ratio | Oil Removal |
| 5 | 0.50 wt % | 98.9 wt % | 0.10 | wt % | 0.50 wt % | 0.2 | 60.20% |
| 6 | 0.50 wt % | 98.8 wt % | 0.20 | wt % | 0.50 wt % | 0.4 | 63.70% |
| 7 | 0.50 wt % | 98.5 wt % | 0.50 | wt % | 0.50 wt % | 1.0 | 63.18% |
| 8 | 0.50 wt % | 97.0 wt % | 2.0 | wt % | 0.50 wt % | 4.0 | 74.64% |
| 9 | 0.50 wt % | 94.0 wt % | 5.0 | wt % | 0.50 wt % | 10.0 | 79.86% |
| 10 | 0.50 wt % | 89.0 wt % | 10.0 | wt % | 0.50 wt % | 20.0 | 78.75% |

*Each wt % is based on the weight of the composition. Minimal foaming was observed for each of Examples 5-10.

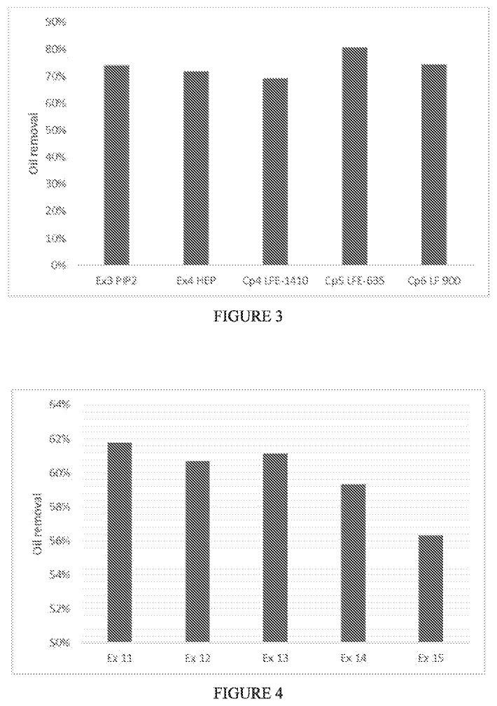

Additional oil removal data is shown in Table 6. Here, the soiled coupon was inserted into a cleaning solution at a temperature of 30° C. The coupon was removed after five minutes. As seen in Table 6, a greater amount of oil removal was observed for a “b/a weight ratio” from 9.0 to 25. See also FIG. 4.

TABLE 6
Cleaning Compositions and Oil Removal Results*

| | | | | |
|---|---|---|---|---|
| | | | b/a Wt. | Oil |
| Example | PIP1 (a) | Water (b) | Ratio | Removal |

| | | | | | |
|---|---|---|---|---|---|
| 11 | 10.0 | wt % | 90.0 wt % | 9.0 | 61.78% |
| 12 | 5.0 | wt % | 95.0 wt % | 19 | 60.70% |
| 13 | 3.8 | wt % | 96.2 wt % | 25 | 61.15% |
| 14 | 3.0 | wt % | 97.0 wt % | 32 | 59.34% |
| 15 | 1.1 | wt % | 98.9 wt % | 90 | 56.31% |

*Each wt % is based on the weight of the composition. Minimal foaming was observed for each of Examples 11-15.

### Foaming Evaluation

A high throughput Phase Identification and Characterization Apparatus robot (see M.C.D. Carter et al., Nonionic Surfactants Promote the Incorporation of Silicone-Acrylic Hybrid Monomers in Emulsion Polymerization, ACS Applied Polymer Materials 2022) was used to conduct a “shake foam” test of each sample composition. The machine consists of an environmental chamber that holds the samples at a constant temperature, a robotic arm that moves the vials from a temperature-controlled stage to an imaging chamber, and a high-resolution camera that captures photographs of the samples against a black background. The samples are illuminated with a LED light oriented at a 900 angle from the camera. Each test composition (see Table 4) was shaken at a pre-set program of the same high intensity and a pre-set duration (60 seconds).

After the shaking was completed, a picture of the composition was taken to record the foam height. For each composition, the composition (3.0 g) was added to a standard glass bottle (volume 8 ml). The “shake foam” test was conducted at room temperature (RT, approx. 22° C.). The amount of foaming was characterized as follows: a) high foaming—foam height ≥16 mm (typically 16—32 mm), b) foaming—foam height from 6 mm to ≤16 mm, c) low foaming—foam height from >0 mm to ≤6 mm, d) no foaming—foam height 0 mm. Also, the appearance of the composition was noted as clear or turbid (cloudy). The results are shown in Table 7 below.

Example 3 (PIP 2), Example 3 (HEP), Comparative 7 (PPZ) and Comparative 9 (AMP) did not generate foam, and each composition was clear in appearance. The ability of a cleaning composition to generate a low amount of foam is an important consideration for metal cleaning compositions, especially those compositions used in a large scale (or industrial scale) metal cleaning process. Excess foaming may result in insufficient rinsing of the metal surface and/or in bath overflows and spills, leading to product waste. Also, good foam control, as seen in each of Example 3 and Example 4, reduces or eliminates the need for an additional foam control agent.

TABLE 7
Foaming Results

| | Ex 3 | Ex 4 | Comp. 7* | Comp. 8* | Comp. 9* | Comp. 4 | Comp. 5 | Comp. 6 |
|---|---|---|---|---|---|---|---|---|
| | PIP2 | HEP | PPZ | MEA | AMP | LFE-1410 | LFE-635 | LF 900 |
| Foam height | 0 | 0 | 0 | 1 | 0 | 2 | 8 | 3 |
| (mm) | | | | | | | | |
| Appearance | Clear | Clear | Clear | Clear | Clear | Turbid | Turbid | Turbid |

*The lower boiling point of each amine makes the respective cleaning solution more prone to evaporation and prone to form an odor.

### Emulsification Evaluation

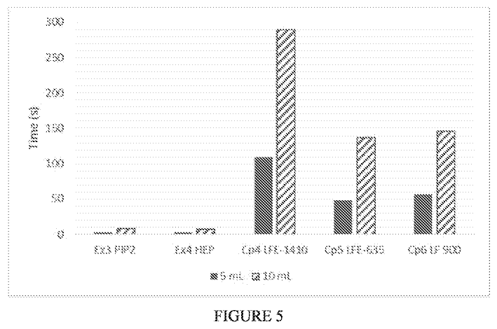

Paraffin liquid (see Table 2) was used as the oil phase. A cleaning composition (20 ml, see Table 4) was added to a graduated cylinder (100 ml), and this addition was followed by 20 ml of the oil. The cylinder was shaken, up and down, for ten times as one cycle. The “up and down” shaking was repeated for five cycles, with an interval of one minute between cycles. After the five cycles were completed, the times needed for the water phase to separate from the oil and reach the 5 ml and then the 10 ml calibration marks were recorded. A longer separation time indicated a stronger emulsification of the cleaning composition and the oil. The results are shown in FIG. 5.

As seen in FIG. 5, Example 3 (PIP 2) and Example 4 (HEP) had weaker emulsifying power (as indicated by a faster oil separation) compared to the surfactants (Comparatives 4-6). A fast oil separation is advantageous in metal cleaning processes, since the cleaning solution is expected to quickly separate from oil after cleaning the metal. A strong binding with an oil may lead to a significant decrease in the efficacy of a cleaning bath, and thus to a shorter bath life. The results herein indicate that Example 3 and Example 4 are optimal cleaning compositions, each for an efficient oil separation and a longer bath life.

Overall, the inventive compositions provide excellent oil removal and low or no foam. Weight ratios can be optimized, as discussed above, to increase the amount of oil removal. Such compositions, as discussed above, also provide a fast separation from oil. The results are obtainable at room temperature. Also the components of each composition are completely soluble at room temperature.

1. A composition comprising at least the following components a and b):
a) at least one N-substituted piperazine selected from Structure 1) below: 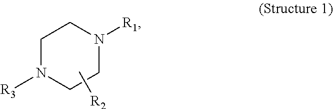
wherein R1 is a C1-C6 alkoxyl group; R2 is H or an alkyl group; R3 is H or a C1-C6 alkoxyl group;
b) water.

2. The composition of claim 1, where the composition further comprises, as component c, a metal carbonate and/or a metal bicarbonate.

3. The composition of claim 2, where the weight ratio of component c to component a is ≥2.0.

4. The composition of claim 2, where the weight ratio of component c to component a is ≤10.

5. The composition of claim 1, where the composition comprises from 88 wt % to 100 wt %, the sum of components a and b, based on the weight of the composition.

6. The composition of claim 1, where, for component a, Structure 1, R1=R3.

7. The composition of claim 1, where, for component a, for Structure 1, R2=H.

8. The composition of claim 1, where, for component a, for Structure 1, R1 is a C2-C4 alkoxyl group.

9. The composition of claim 1, where, for component a, for Structure 1, R3 is a C2-C4 alkoxyl group.

10. The composition of claim 1, where, for component a, for Structure 1, R3 is H.

11. The composition of claim 1, where component a is at least one structure selected from the group consisting of the following structures 1a) through 1c) as shown below:
1a) 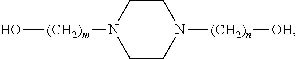
where n is an integer from 1 to 6; and m is an integer from 1 to 6; 1b) 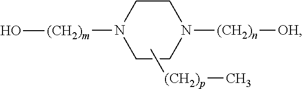
where n is an integer from 1 to 6; and m is an integer from 1 to 6; p is an integer from 1 to 6; and
1c) mixture of structure 1a) and structure 1b).

12. The composition of claim 1, where component c is a metal carbonate.

13. The composition of claim 1, where the component a is present in an amount from 0.01 wt % to 20 wt %, based on the weight of the composition.

14. The composition of claim 2, where the sum of component a, b and c is present in an amount from 95.0 wt % to 100 wt %, based on the weight of the composition.

15. The composition of claim 1, where the composition further comprises, as component d, a metal chelate.

16. The composition of claim 1, where the composition has an “oil removal %”≥60%, as determined from the equation [(W2−W3)/(W2−W1)]×100, where W1=weight of a stainless steel coupon, W2=weight of the oil soiled coupon, and W3=weight of the dried coupon after subject to cleaning evaluation with the composition (see experimental section).

17. The composition of claim 1, where the composition generates a foam height ≤5 mm, after 60 seconds of shaking using a high throughput robot (see experimental section).

18. A process to form the composition of claim 1, the process comprising mixing at least components a and b.

19. A process to clean a metal surface, the process comprising applying to the metal surface the composition of claim 1.

20. The process of claim 19, where the temperature of the composition is from 18° C. to 29° C., when applied to the metal surface.
